(19) United States
(12) Patent Application Publication
(10) Pub. No.: US 2001/0021301 A1
(43) Pub. Date: Sep. 13, 2001

(54) Substrate having V-shaped grooves and a manufacturing method therefor, and optical fiber array

(75) Inventors: Masashi Fukuyama, Komaki (JP); Kazutoshi Tohyama, Nakastugawa (JP)

Correspondence Address: BURR & BROWN, PO BOX 7068, SYRACUSE, NY, 13261-7068, US

(73) Assignee: NGK Insulators, Ltd.

(21) Appl. No.: 09/778,395

(22) Filed: May 4, 2001

(30) Foreign Application Priority Data
Mar. 26, 1999 (JP) 11-084,958

(51) Int. Cl. G02B 6/36

(52) U.S. Cl. 385/137; 264/1.25

(57) ABSTRACT

To provide a substrate having V-shaped grooves including: a V-groove portion having a plurality of V-grooves; a flat portion; and a stepped portion connecting the V-groove portion to the flat portion. The stepped portion is formed so as to be curved convexly toward the surface thereof. There is also provided an optical fiber array including: the substrate having V-shaped grooves; and a fiber holding substrate for holding at least fibers inserted and arranged in the V-grooves in the substrate having V-shaped grooves. A stress concentration on the fiber can be prevented and the stress can be decreased as a whole.

### BACKGROUND OF THE INVENTION AND RELATED ART STATEMENT

The present invention relates to a substrate having V-shaped grooves capable of being used suitably for an optical fiber array and a manufacturing method therefor, and an optical fiber array using the substrate having V-shaped grooves.

In recent years, the laying and use of optical fibers have rapidly been in progress. As optical fiber arrangement parts, an optical fiber array for connecting optical fibers to other optical parts and an MT connector for connecting optical fibers to each other are well known.

As is shown in FIG. 15(a), a substrate having V-shaped grooves 9 for mounting and arranging such optical fibers in V-grooves, especially as a substrate for optical fiber array on which not only uncovered (bare) optical fibers but also covered optical fibers are mounted, has a V-groove portion 1 and a lower flat portion 2 for mounting covered optical fibers. Conventionally, the lower flat portion 2 is formed by grinding or Si etching of a substrate.

In this case, however, although a stepped portion 3 connecting the V-groove portion 1 to the lower flat portion 2 can be provided with a taper 4 as shown in FIG. 16(a), the taper 4 is formed into a straight shape, and a V-groove edge 5 is in a sharply rising state. The optical fiber array using such a substrate having V-shaped grooves is configured so that, as shown in FIGS. 15(b) and 16(b), an end portion where the fiber is pressed by an upper substrate 6 (the start of stepped portion of an upper substrate integration type or the start of the R portion of fiber pressing substrate) 7 and a start of stepped portion 8 of the substrate having V-shaped grooves 9 coincide with each other in the lengthwise direction to make the upside and downside stress distributions uniform to the utmost.

Therefore, in the case where the stepped portion 3 has an angle of 90 degrees as shown in FIGS. 15(a) and 15(b), the stress of adhesive changes suddenly as shown in FIG. 15(c), and moreover a portion where the stress increases and the V-groove edge 5 substantially coincide with each other, so that a support point in the case where the fiber moves transversely and a vertical support point substantially coincide with each other. Thereupon, stresses concentrate on the fiber, so that there is a fear of increase in loss, and in the worst case, fiber breakage etc. may be caused. Also, in the case where the stepped portion 3 has an angle of 90 degrees, the distance through which the fiber is in contact with the V-groove edge 5 is short, so that if stresses such as the aforementioned adhesive stress and bending stress occur, the stresses concentrate in this portion, so that there is a fear that the same problems as described above arise.

To prevent these problems, in the optical fiber array shown in FIG. 16(b), which uses the substrate having V-shaped grooves 9 in which the stepped portion 3 is tapered as shown in FIG. 16(a), the adhesive portion is formed so as to expand gradually to provide a smooth stress distribution such that the occurring stress increases gradually, by which the above-described problems are overcome.

However, if the taper angle of the stepped portion 3 increases, the taper portion becomes long, so that the quantity of adhesive increases as a whole. Therefore, the stress in the hatched portion A in FIG. 16(c) increases. To solve this problem, a proper taper angle has conventionally been set while making adjustment in this respect.

Also, in order to overcome the above-described problems caused by the configuration such that the V-groove edge 5 of the stepped portion 3 rises sharply, a method in which the edge 5 is rounded by using a rubber grinding stone, partial buffing, or the like has been studied. However, since the depth of V-groove is as small as about 100 to 150 μm, the operation is difficult to do, and the unrounded edge remains partially, which presents a problem of unstable quality.

The present invention has been made to solve the problems with the prior art, and accordingly an object thereof is to provide a substrate having V-shaped grooves, in which the stress concentration on the fiber can be prevented and the stress can be decreased as a whole, and a manufacturing method for the substrate having V-shaped grooves, and an optical fiber array using the substrate having V-shaped grooves.

### SUMMARY OF THE INVENTION

According to the present invention, there is provided a substrate having V-shaped grooves including: a V-groove portion having a plurality of V-grooves; a flat portion; and a stepped portion connecting the V-groove portion to the flat portion, characterized in that the stepped portion is formed so as to be curved convexly toward the surface thereof.

In the present invention, an edge portion of each of the V-grooves is preferably formed into a rounded shape.

Also, according to the present invention, there is provided a manufacturing method for a substrate having V-shaped grooves, in which a glass material is press molded by using a one-piece mold having a molding face corresponding to the surface shape of the substrate having V-shaped grooves.

Further, according to the present invention, there is provided a manufacturing method for a substrate having V-shaped grooves, characterized by comprising a primary fabrication process for molding a glass substrate having a stepped shape; and a secondary fabrication process for press molding the glass substrate having a stepped portion obtained by the primary fabrication process by using an upper mold and lower mold each having a V-grooved surface, thereby a substrate having a V-groove portion, a flat portion and a stepped portion is molded; the stepped portion being formed so as to be curved convexly toward the surface thereof. According to this manufacturing method, a substrate having V-shaped grooves in which an edge portion of each V-groove is formed into a rounded shape can be molded. In this case, the primary fabrication process may be accomplished by grinding.

Still further, according to the present invention, there is provided an optical fiber array including the substrate having V-shaped grooves configured as described above and a fiber holding substrate for holding at least fibers inserted and arranged in V-grooves in the substrate having V-shaped grooves.

### BRIEF DESCRIPTION OF THE DRAWINGS

FIG. 1 is a perspective view showing one embodiment of a substrate having V-shaped grooves in accordance with the present invention.

FIG. 2(a) is a sectional view for illustrating one embodiment of an optical fiber array using a substrate having V-shaped grooves in accordance with the present invention, and FIG. 2(b) is a graph showing stress distribution in the optical fiber array.

FIG. 3 is an explanatory view for illustrating a degree of roundness curved into a convex shape in a stepped portion.

FIG. 4(a) is a perspective view of a substrate on which a stepped portion is made, and FIG. 4(b) is an explanatory view showing a state in which glass is pushed out in press molding.

FIG. 5 is an explanatory view showing a tip end shape of a grinding stone.

FIG. 6 is an explanatory view showing a state in which a mold material is ground with the grinding stone.

FIG. 7(a) is a plan view of a mold material, FIG. 7(b) is a view in which the mold material is viewed from the start face of grinding operation with a grinding stone, and FIG. 7(c) is a side view of the mold material.

FIG. 8(a) is a plan view of a mold material both end portions of which are ground, FIG. 8(b) is a view in which the mold material is viewed from the start face of grinding operation with the grinding stone, and FIG. 8(c) is a side view of the mold material.

FIG. 9(a) is a plan view showing one example of a substrate having V-shaped grooves press molded by using a one-piece mold, FIG. 9(b) is a view taken from a V-groove portion, and FIG. 9(c) is a side view of the substrate having V-shaped grooves.

FIG. 10 is an explanatory view showing a relationship between the radius of grinding stone, the height of rounded portion, and the length of rounded groove.

FIG. 11(a) is a plan view showing one example of a wafer on which stepped portions are made, and FIG. 11(b) is a side view thereof.

FIG. 12(a) is a plan view showing one example of a wafer in which V-grooves are formed, and FIG. 12(b) is a side view thereof.

FIG. 13 is an explanatory view showing one example of an optical fiber array.

FIG. 14 is a photograph showing a structure of a ceramic material (glass material) forming a stepped portion of a substrate having V-shaped grooves.

FIG. 15(a) is a perspective view showing one example of a conventional substrate having V-shaped grooves, FIG. 15(b) is a sectional view of a fiber array using the conventional substrate having V-shaped grooves shown in FIG. 15(a), and FIG. 15(c) is a graph showing stress distribution in the fiber array.

FIG. 16(a) is a perspective view showing another example of a conventional substrate having V-shaped grooves, FIG. 16(b) is a sectional view of a fiber array using the conventional substrate having V-shaped grooves shown in FIG. 16(a), and FIG. 16(c) is a graph showing stress distribution in the fiber array.

### DETAILED DESCRIPTION OF PREFERRED EMBODIMENT

An embodiment of the present invention will now be described in detail with reference to the accompanying drawings. The present invention is not limited to this embodiment.

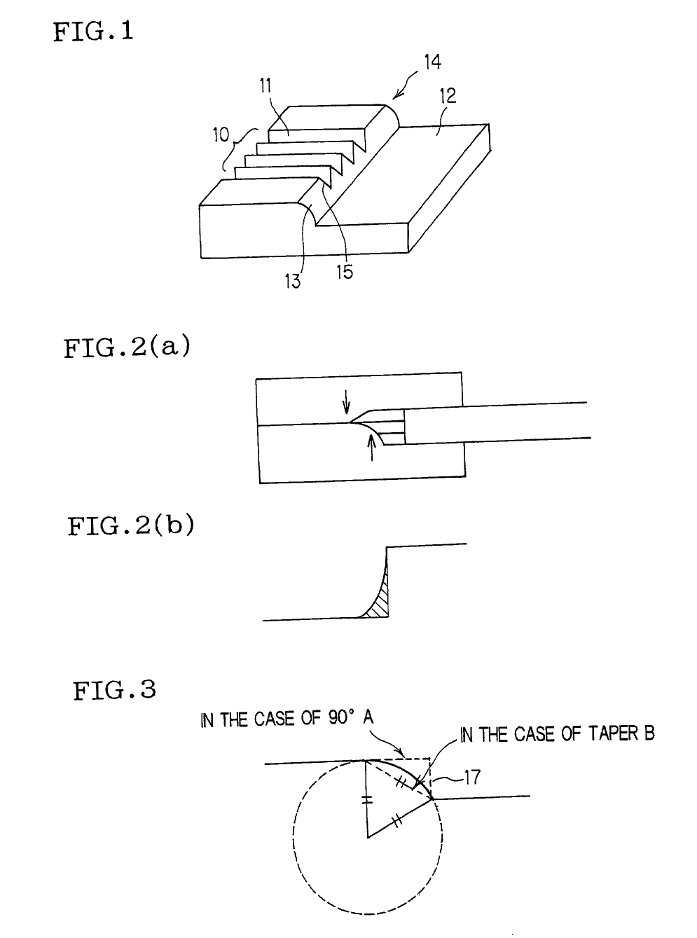

FIG. 1 is a perspective view showing one embodiment of a substrate having V-shaped grooves in accordance with the present invention. FIG. 2(a) is a sectional view for illustrating one embodiment of an optical fiber array using the substrate having V-shaped grooves in accordance with the present invention, and FIG. 2(b) is a graph showing stress distribution in the optical fiber array.

In FIG. 1, reference numeral 10 denotes a V-groove portion having a plurality of V-grooves 11. In the V-groove portion 10 are arranged and disposed uncovered (bare) optical fibers. Reference numeral 12 denotes a flat portion. On the flat portion 12 are mounted covered optical fibers. The V-groove portion 10 is connected to the flat portion 12 via a stepped portion 13, by which a substrate having V-shaped grooves 14 is formed.

The stepped portion 13 is formed so as not to be tapered straight but so as to have a roundness curved into a convex shape toward the surface thereof.

Due to the stepped portion 13 curved convexly toward the surface thereof as described above, the substrate having V-shaped grooves 14 has the following operation and effects:

(1) As regards the stress distribution of adhesive, a taper with a low angle is provided from the tip end (portion where the fiber is fixed), so that the stress increases gradually. Therefore, the stress concentration on the fiber can be prevented.

(2) Since a position where the fiber hits the V-groove edge lies at the rear, the stress support point shifts more greatly when the fiber moves vertically or transversely. Therefore, the stress concentration can be prevented.

(3) While the above-described operation and effects are achieved, the total amount of increase in stress (amount of increase in adhesive) is small.

(4) Since the angle of a portion where the fiber hits the V-groove edge is lower than that of the tapered stepped portion, the contact area increases. Therefore, even if the same stress is applied, the stress is distributed.

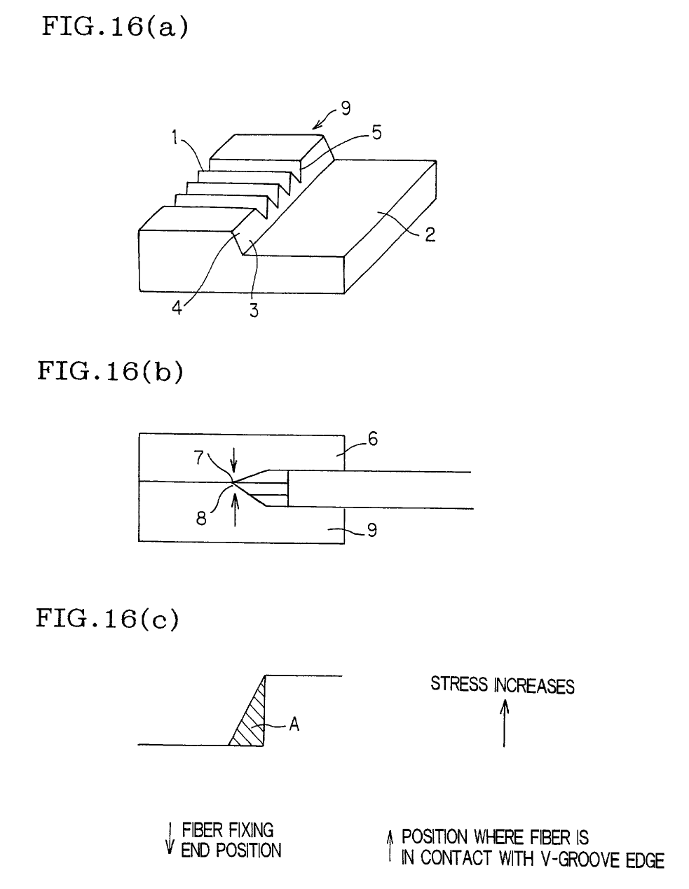

When the taper shown in FIGS. 16(a), 16(b) and 16(c) is formed, the taper angle of about 30° through 60° is proper. In the case where the stepped portion of the present invention has a rounded shape curved convexly, it is preferable that roundness curved convexly be formed with respect to the straight line having this angle.

The degree of roundness is preferably about a rounded shape whose radius is the distance of tapered portion as shown in FIG. 3. However, the rounded shape need not be a completely rounded shape as shown in FIG. 3. It may lie in the range of the triangle indicated by broken lines in FIG. 3 (specifically, the triangle formed by the cross-sectional shape A in the case of 90° and the cross-sectional shape B in the case of taper) 17. In this case, the rounded shape may be distorted slightly.

Also, in the substrate having V-shaped grooves shown in FIG. 1, an edge portion 15 of individual V-groove 11 rises even in the case where the stepped portion 13 is formed into a rounded shape. In order to further reduce danger of increased loss and broken fiber, the edge portion 15 of individual V-groove 11 is preferably rounded.

The following is a description of a method for forming the roundness.

Conventionally, as a method for forming the roundness, buffing has been performed lightly, or partial grinding has been performed with a router provided with a rubber grinding stone or the like. In this case, however, there arises a problem in that a roundness is formed only partially, a sharp edge remains, the roughness is high, a flaw is produced microscopically, and the effects are decreased.

Contrarily, for the roundness formed at the edge portion in the present invention, roundness is formed over the whole depth of the end portions of all V-grooves. Thereby, stress is distributed by the rounded shape even if a stress due to bending or adhesive is applied to the fiber, so that high quality can be maintained. In addition, since the roundness is formed over the whole, a problem in that a microscopic flaw is produced and thereby the strength is decreased in handling at the time of manufacture (assembly) of a fiber array can be overcome. Since there is a possibility that the fiber hits the edge portion of V-groove in various states at the time of assembly of a fiber array, it is important that the roundness be formed over the whole.

Next, a manufacturing method for a substrate having V-shaped grooves in accordance with the present invention will be described.

(Manufacturing Method 1)

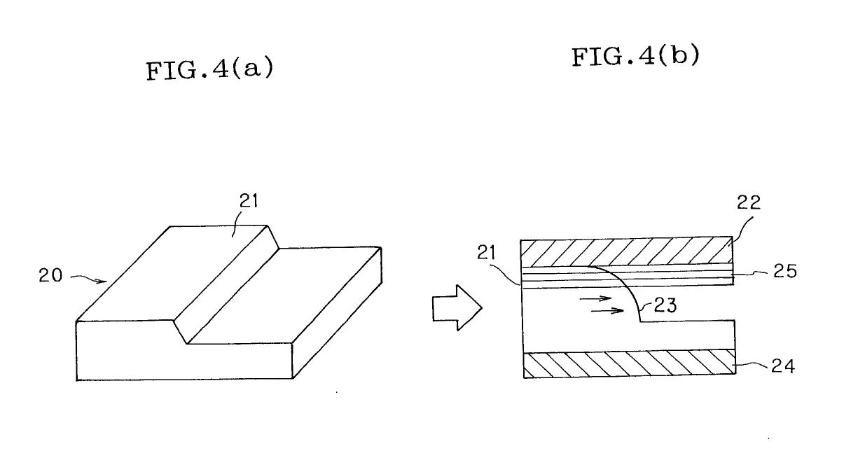

First, a substrate having a stepped portion 20 as shown in FIG. 4(a) is subjected to V-groove press molding. Thereby, the stepped portion is formed into a rounded shape curved convexly (hereinafter referred to as rounded stepped portion), and the edge portion of each V-groove is rounded (hereinafter referred to as edge roundness).

As a method for forming rounded stepped portion and edge roundness, a method of V-groove pressing on a substrate having difference in level (straight) can be given. In this method, on the substrate 20 as shown in FIG. 4(a) on which a difference in level is formed in advance by primary fabrication, V-grooves are formed and the stepped portion is rounded by press molding.

The V-grooves are formed in an upside flat portion 21 of the substrate 20 shown in FIG. 4(a). As shown in FIG. 4(b), the portion 21 is pressed by an upper mold 22 when molding is performed in secondary fabrication, so that glass is pushed out to a stepped portion 23, by which the V-grooves are formed. By this pushing-out operation during molding, the stepped portion 23 is naturally formed into a rounded stepped portion having a rounded shape. Therefore, the rounded stepped portion can be realized merely by V-groove molding of the substrate 20 formed with the difference in level without special shaping performed by using a mold or the like. In FIG. 4(b), reference numeral 24 denotes a lower mold, and 25 denotes a convex portion of upper mold.

Depending on the molding conditions, at the time of V-groove formation, the dimensions of the stepped portion shrink by 10 to 100% in depth and 5 to 50% in width and length.

Also, since the V-groove formation is accomplished at a temperature higher than temperature at which glass is deformed (Td), a portion that is not in direct contact with the mold has a smooth surface. Therefore, the edge portion of V-groove has a smooth surface and decreased viscosity while being deformed as described above during molding, so that the rounded shape is naturally formed. Specifically, individual V-groove edge can be rounded naturally by the V-groove formation in the substrate formed with difference in level, so that surely uniform roundness can be realized without the need for special fabrication.

(Manufacturing Method 2)

Also, as a method for forming the rounded stepped portion and the edge roundness on a substrate having V-shaped grooves, a reheat press molding using a one-piece mold can be given.

The following is a description of a manufacturing method for one-piece mold having a rounded shape and a molding method using the one-piece mold.

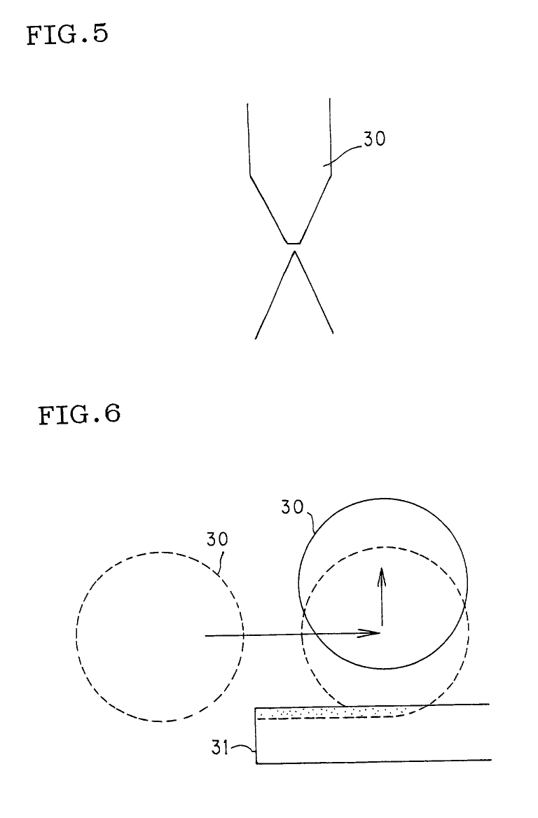

First, a mold is fabricated by a microgrinder. A grinding stone 30 is a circular diamond grinding stone with a diameter of 90 mm, and the tip end shape thereof is trapezoidal as shown in FIG. 5. By using this grinding stone 30, as shown in FIG. 6, a mold material 31 measuring 5 mm×8 mm×10 mm (height) is ground from the end thereof. By stopping the advance of the grinding stone 30 and moving it upward, the ground portion is provided with a straight portion and a rounded portion having the same circular shape as that of the grinding stone 30.

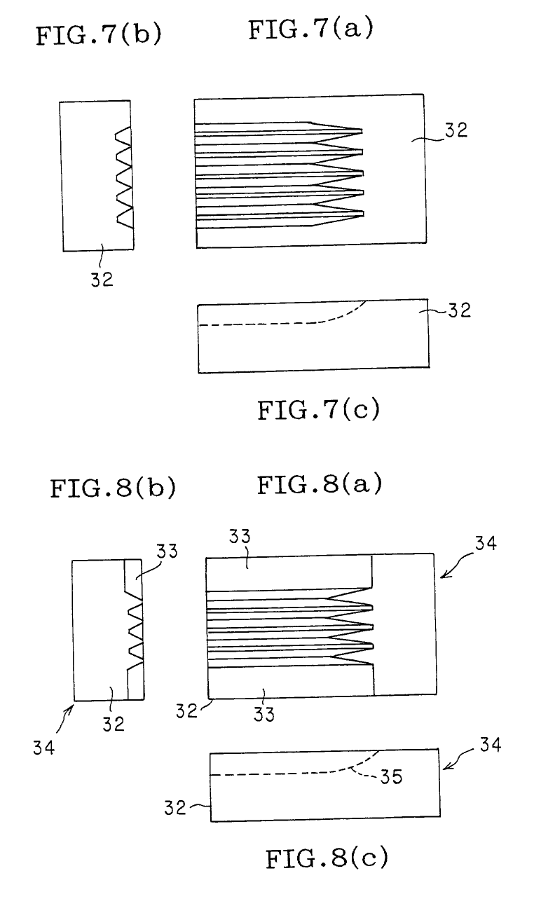

Five rows of grooves are processed at intervals of 0.25 mm in the top surface of the mold material 31 by this grinding operation, by which a mold material 32 shown in FIGS. 7(a), 7(b) and 7(c) can be obtained. Here, FIG. 7(a) is a plan view of the mold material, FIG. 7(b) is a view in which the mold material is viewed from the start face of grinding operation with the grinding stone, and FIG. 7(c) is a side view of the mold material.

Next, by using the similar diamond grinding stone having a trapezoidal tip end flat portion of 3 mm, both end portions 33 of the five-row groove group having been fabricated are ground so that the fabrication is stopped at the same position as shown in FIGS. 8(a), 8(b) and 8(c) on the mold material 32. At this time, grinding is performed including the outside slant faces of the first-row and fifth-row grooves, by which a one-piece mold 34 for manufacturing the substrate having V-shaped grooves can be obtained. In this one-piece mold 34, the fabricated face also has a curved portion 35 formed by the rounded portion of the grinding stone with a diameter of 90 mm that is the same as that of the five grooves.

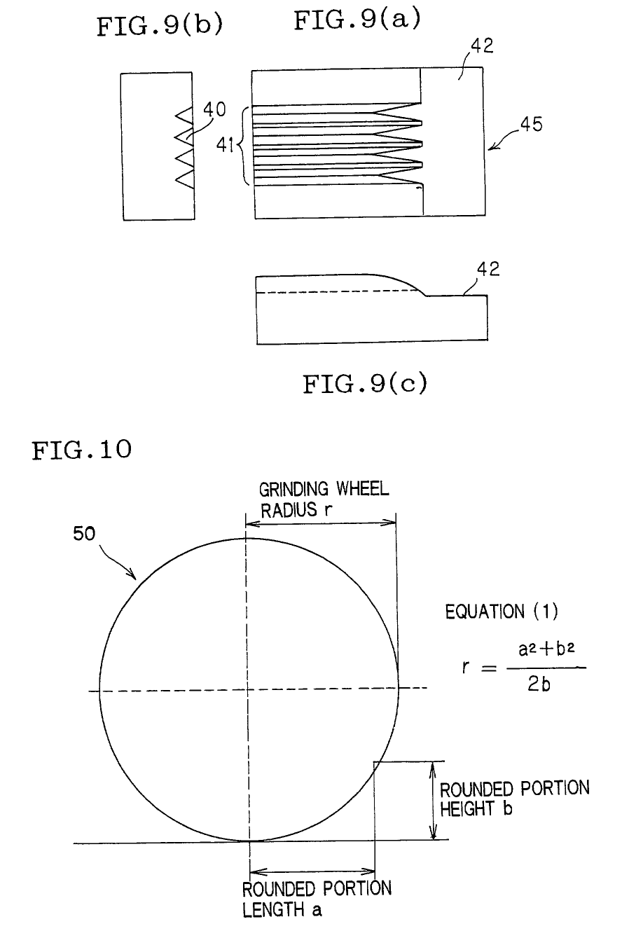

By using the one-piece mold 34 obtained in this manner, reheat press molding of a glass material is performed. Thereby, a glass-made substrate having V-shaped grooves 45 as shown in FIGS. 9(a), 9(b) and 9(c) can be molded. The substrate having V-shaped grooves 45 is formed with a rounded stepped portion (rounded shape curved convexly toward the surface) at a stepped portion 43 at the boundary between a V-groove portion 41 having four rows of V-grooves 40 and a covered fiber housing portion 42, which is a lower flat portion for mounting covered fibers.

Here, the reheat press molding will be explained. First, a glass block having been obtained by cooling and solidifying molten glass is cut and ground into a block having an almost the same shape as a product to be obtained by reheat press molding. For example, in the case where the press molded product measures 20×20×2 mm (volume: 800 mm³), the glass block is cut and ground into almost the same size (almost the same volume) of, for example, 19×19×2.2 mm (volume: 800 mm³) so that it can be inserted into a mold, and finally the above-described product dimensions can be obtained. Next, the glass block is inserted into the mold and is heated, by which the glass block is slightly softened. In this state, molding is performed by applying a pressure, by which a fine shape on the mold is transferred to the glass block, and a molded product having high shape accuracy is manufactured.

Reheat press molding was performed for a molding time of 60 seconds at a molding temperature of 600° C. under a molding pressure of 50 kg using Miraclon PC-4 made by NGK Insulators, Ltd. as the glass material. As a result, one wafer could be molded in about 10 minutes. This manufacturing method has higher productivity than the manufacturing method 1 because the stepped portion forming process can be omitted

Also, in the manufacturing method 1, although not only the rounded stepped portion but also the V-groove edge roundness can be formed at the time of press molding, the dimension of difference in level may vary by 20 to 30 μm because this method effectively uses the outflow of glass. Therefore, it is necessary to strictly set the molding conditions. On the other hand, in the manufacturing method 2, the stepped portion can also be molded integrally with a dimensional error in the order of Mm because the difference in level is formed by the one-piece mold.

Further, by fabricating a plurality of rows on a large mold measuring, for example, 50×50×10 mm by using the above-described grinding method, a large number of the same shapes can be transferred by one press molding operation. Therefore, mass production can be accomplished by cutting the wafer into chips.

Since the rounded shape is determined by the diameter of a V-groove grinding stone 50, the following equation holds as shown in FIG. 10.

$$r = \frac{{a}^{2} + {b}^{2}}{2 b}$$

Specifically, since the depth of V-groove portion of the fiber array is determined by the V-groove pitch and V-groove angle, an arbitrary depth can be set by the setting of a rounded groove length (a) and a grinding stone radius (r) if a rounded portion height (b) is more than the V-groove depth.

However, in the manufacturing method 2, since the roundness of V-groove edge cannot be formed in molding, rounding operation was performed by brushing in the subsequent process. With this method, the V-groove edge can be rounded relatively uniformly. The brushing operation is performed while supplying diamond abrasive grains with a size of about 1 to 6 μm by rotating a brush using ditch reed fiber at a rotational speed of 60 to 100 rpm. According to this method, rounding is performed from the stepped portion to the V-groove, and thereby the ridge of V-groove is also rounded, which is preferable because the fiber can be prevented from being damaged at the time of fiber assembly.

Next, the present invention will be described further in detail with reference to the embodiment.

The substrate having V-shaped grooves in accordance with the present invention was applied to three-part component of eight-core optical fiber array manufactured of Pyrex (glass material made of Corning Inc.).

The product size was 7 mm (width)×10 mm (length)×3 mm (thickness).

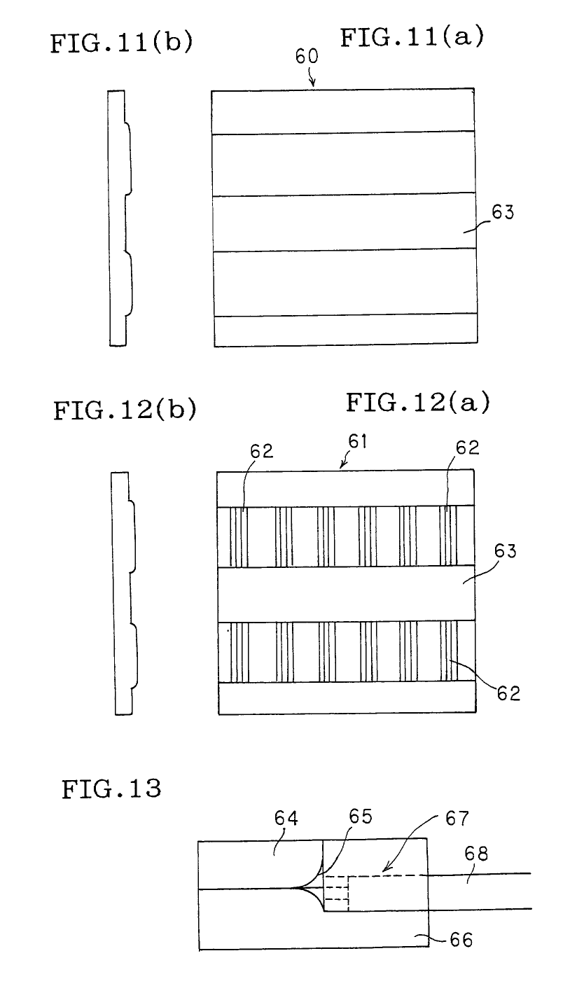

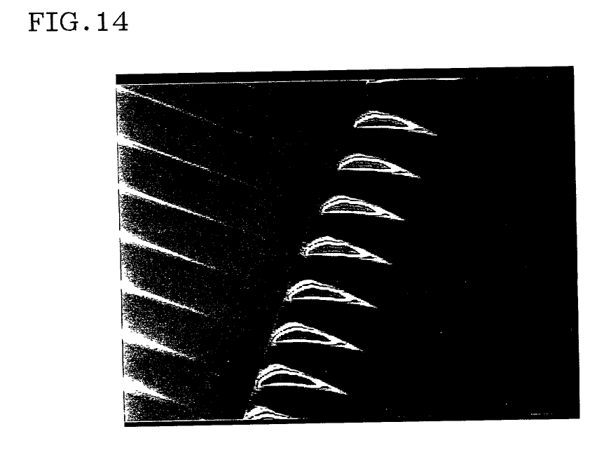

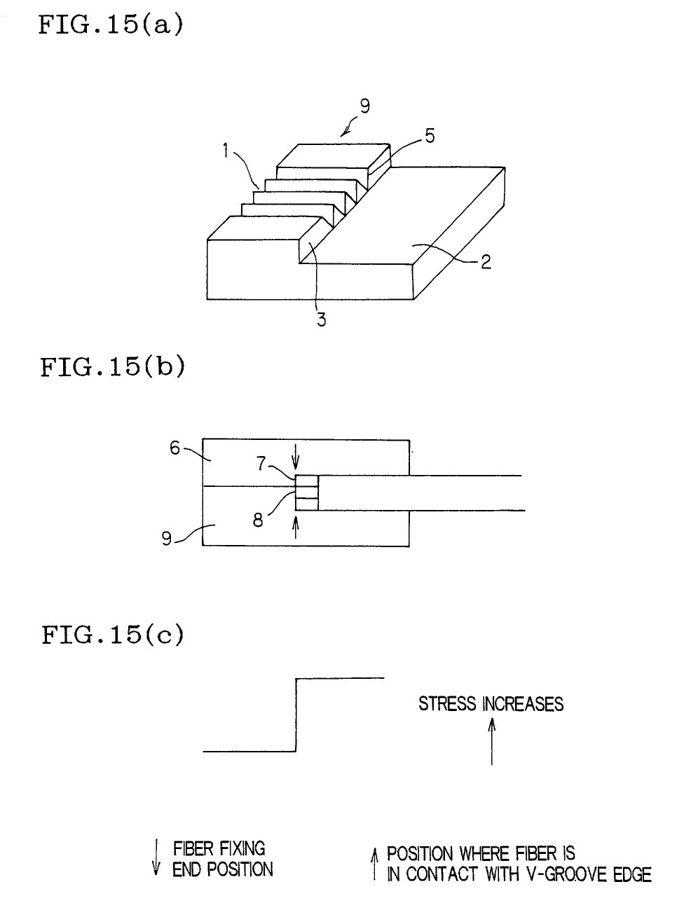

First, as shown in FIGS. 11(a) and 11(b), a wafer 60 on which a stepped portion had been formed by grinding was prepared, and V-grooves 62 were press molded in the top surface thereof. Thus obtained wafer having v-shaped grooves 61 is shown in FIGS. 12(a) and 12(b). The wafer 60 had a size of 50 mm square from which 24 chips can be taken (6 in the width direction×4 in the length direction). The press molding was performed under conditions of a temperature of 700° C., a press pressure of 1500 kg, and a press time of 240 seconds. The stepped portion of the obtained substrate having V-shaped grooves is shown in the photograph of FIG. 14.

After a covered fiber housing substrate was bonded and fixed to a lower flat face 63 of the wafer 60, the cutting-off of chips was performed.

Next, for the obtained chip, a fiber fixing end 65 of a fiber holding substrate 64 was rounded as shown in FIG. 13 to prevent a fiber from being damaged. Then, a fiber 68 was inserted in chip consisting of a substrate having V-shaped grooves 66 and a covered fiber housing substrate 67, and the fiber was mounted in the V-groove. Thereafter, the fiber was held by the fiber holding substrate 64, and was cured with an adhesive, and the end face thereof was ground, by which an optical fiber array as shown in FIG. 13 was manufactured.

As described above, according to the present invention, there can be provided a substrate having V-shaped grooves, in which the stress concentration on the fiber is prevented and the stress can be decreased as a whole, and a manufacturing method for the substrate having V-shaped grooves, and an optical fiber array.

What is claimed is:

1. A substrate having V-shaped grooves, comprising:
a V-groove portion having a plurality of V-grooves;
a flat portion; and
a stepped portion connecting said V-groove portion to said flat portion,
characterized in that said stepped portion is formed so as to be curved convexly toward the surface thereof.

2. The substrate having V-shaped grooves according to claim 1, characterized in that an edge portion of each of said V-grooves is formed into a rounded shape.

3. A manufacturing method for a substrate having V-shaped grooves, characterized in that a glass material is press molded by using a one-piece mold having a molding face corresponding to a surface shape of said substrate having V-shaped grooves, thereby a substrate having V-shaped grooves comprising a V-groove portion having a plurality of V-grooves, a flat portion and a stepped portion connecting said V-groove portion to said flat portion is molded; and said stepped portion being formed so as to be curved convexly toward the surface thereof.

4. A manufacturing method for a substrate having V-shaped grooves comprising comprises a V-groove portion, a flat portion, and a stepped portion; said method being characterized by comprising:
a primary fabrication step for molding a glass substrate having a stepped shape, and
a secondary fabrication step for press-molding the glass substrate having a stepped shape obtained by said primary fabrication step by using an upper mold and lower mold each having a V-grooved surface,
wherein said stepped portion is formed by molding so as to be curved convexly toward direction of its surface.

5. The manufacturing method for a substrate having V-shaped grooves according to claim 4, characterized in that a substrate having V-shaped grooves in which an edge portion of each of V-grooves is formed into a rounded shape is molded.

6. An optical fiber array,
characterized in that a substrate having V-shaped grooves comprises
a V-groove portion having a plurality of V-grooves;
a flat portion; and
a stepped portion connecting said V-groove portion to said flat portion, and
said stepped portion being formed so as to be curved convexly toward the surface thereof; and
a fiber holding substrate for holding at least fibers inserted and arranged in the V-grooves in said substrate having V-shaped grooves.

7. An optical fiber array,
characterized in that a substrate having V-shaped grooves comprises
a V-groove portion having a plurality of V-grooves,
a flat portion, and
a stepped portion connecting said V-groove portion to said flat portion; said stepped portion being formed so as to be curved convexly toward the surface thereof and an edge portion of each of said V-grooves being formed into a rounded shape; and
a fiber holding substrate for holding at least fibers inserted and arranged in the V-grooves in said substrate having V-shaped grooves.
